(19) United States
(12) Patent Application Publication
(10) Pub. No.: US 2019/0157980 A1
(43) Pub. Date: May 23, 2019

(54) HIGH FREQUENCY HIGH POWER CONVERTER SYSTEM

(71) Applicant: THE UNIVERSITY OF NOTTINGHAM, Nottingham (GB)

(72) Inventors: Chao JI, Nottingham (GB); Alan James WATSON, Nottingham (GB); Jonathan Charles CLARE, Nottingham (GB)

(73) Assignee: THE UNIVERSITY OF NOTTINGHAM, Nottingham (GB)

(21) Appl. No.: 16/314,403

(22) PCT Filed: Jun. 29, 2017
(86) PCT No.: PCT/GB2017/051894

§ 371 Date: Dec. 29, 2018

(30) Foreign Application Priority Data
Jun. 30, 2016 (GB) 1611493.6

(51) Int. Cl. H02M 3/335; H02M 1/42; H05B 6/68

(52) U.S. Cl. CPC H02M 3/33592; H05B 6/683; H05B 6/685; H02M 1/4208

(57) ABSTRACT

A high frequency high power converter system comprises: a plurality of resonant tank circuits arranged in parallel, a plurality of transformers, each transformer having a single primary winding and a plurality of secondary windings, and a vacuum electronic device, the output of each resonant tank circuit being applied to a respective different transformer and the outputs of the transformers being arranged to drive the vacuum electronic device.

### CROSS-REFERENCE TO RELATED APPLICATION

This application is a U.S. National Stage Application of International Patent Application No. PCT/GB2017/051894, filed Jun. 29, 2017, which claims benefit of United Kingdom Patent Application No. 1611493.6, filed Jun. 30, 2016.

### FIELD OF THE INVENTION

This invention relates to high frequency high power converter systems and more particularly, but not exclusively, to systems which include a magnetron.

### BACKGROUND

There are increasing requirements for compact power supplies having high power density and high efficiency. In previous arrangements using switch-mode converters, controlled semiconductor devices are used to turn on or turn off the entire load current during each switching action. For frequencies of the order of a few kilohertz, for example, 2.5 kHz, such arrangements have proved acceptable. However, at higher frequencies, there is switching loss and switching stress of the semiconductor devices as both are linearly proportional to the switching frequency. Also, electromagnetic interference (EMI) created by large current and voltage derivatives can be a significant issue.

### SUMMARY

According to the invention, a high frequency high power converter system comprises: a plurality of resonant tank circuits arranged in parallel, a plurality of transformers, each transformer having a single primary winding and a plurality of secondary windings, and a vacuum electronic device, the output of each resonant tank circuit being applied to a respective different transformer and the outputs of the transformers being arranged to drive the vacuum electronic device.

The vacuum electronic device may be a magnetron or another type of vacuum electronic device such as a klystron, for example. In one embodiment, a magnetron is operated as a continuous wave (CW) magnetron but in others, it is pulsed.

In one embodiment, three transformers are included in a three-paralleled single phase configuration, giving high efficiency characteristics for a wide range of operating points and high resilient properties in the presence of imbalances in the resonant tank circuits. For high power high voltage applications, the use of the multi-phase configuration relieves the electrical pressure for the semiconductor devices and the resonant elements significantly, and also results in a great reduction on the size of filter requirements owing to ripple cancellation. It allows operation at high frequency with high efficiency, resulting in smaller transformers, filters and associated costs. In one embodiment, the power level is 100 kW and the switching frequency is 20-30 kHz.

In one embodiment, each of the plurality of resonant tank circuits is a series resonant, series loaded resonant tank. A series resonant series loaded (SRSL) resonant tank is able to operate safely under the open circuit condition. This is particularly advantageous where the load is a magnetron. In another embodiment, each of the plurality of resonant tank circuits is a series resonant parallel loaded (SRPL) tank. Other configurations are possible.

In one embodiment, a plurality of inverter circuits is included. Each inverter circuit comprises a plurality of semiconductor switches and a respective different inverter of said plurality is connected to the input of each of the plurality of resonant tank circuits. The inverter circuits may each comprise four semiconductor switches connected as an H-bridge. However, other configurations may be used, such as half bridge or three-phase bridge or other similar configurations.

In one embodiment, the semiconductor switches are IGBT switches but other types could be used. The IGBT switches may be included in standard, off-the-shelf modules, which are relatively low cost and readily sourced.

The inverter circuits may be controlled to provide substantially zero voltage soft switching of the semiconductor switches. One advantageous way in which this may be achieved is by using combined frequency and phase shift modulation, CFPM, to control the inverter circuits to provide substantially zero current/zero voltage soft-switching (ZVS), that is switching the semiconductor switches when they are not conducting current or not supporting voltage. In one embodiment, independent control of soft-switching in each of the phases is implemented, giving flexibility. This contrasts with previous systems in which hard switching is used. In hard switching, there is abrupt commutation of current from one semiconductor switch device to another accompanied by abrupt change in voltage across device, and each switching transition causes energy loss. As average power loss is governed by the energy loss of each transition at a device and the switching frequency, this limits the switching frequency limitation for acceptable efficiency.

The size of a transformer is directly related to the frequency at which it is designed to operate and at higher frequencies, the components are usually smaller. However, the higher the frequency, the higher the losses associated with switching semiconductors and the lower the system efficiency. Soft switching allows the power electronics to switch at high frequencies without impacting significantly on efficiency. A further advantage of operating at high frequencies is the reduced requirements for filtering at the load. For a magnetron load, the current flowing through the tube should have minimal ripple, that is, it should be flat, to obtain a good quality RF output. Filtering is used to achieve this and at higher frequencies of operation, filtering components can be smaller. This has a further advantage that under arc conditions in the magnetron, the energy transferred from the filter components into the magnetron is significantly lower than previous systems, thus extending the lifetime of the magnetron.

Over time, the phase difference between the resonant tank current and voltage may change, resulting in a loss of soft switching, In one embodiment, a tracking arrangement in included to counteract any deviation from substantially zero current soft switching of the semiconductor switches. The tracking arrangement may be such that it generates a correction frequency to provide substantially zero current soft switching (ZCS) of the semiconductor switches. In ZCS, the semiconductor switches are switched when they are not in the circuit current path.

In one embodiment, a respective high voltage rectifier is connected to the each secondary winding of the plurality of secondary windings. A capacitance may be connected across the output of each high voltage rectifier and the capacitances connected in series with one another.

In one advantageous embodiment, three transformers are included and the power applied to the primary windings of the three transformers is mutually phase shifted by 120 degrees. In other embodiments, two transformers or more than three transformers may be included. However, using three transformers in three branches results in a lower ripple output than a two transformer arrangement and has lower costs than a converter with four or more transformers and their associated circuitry and components. Adopting a multi-phase approach achieves harmonic cancellation and thus less filtering is required, reducing losses and size requirements.

In one embodiment, a utility interface power converter is included, having an input for receiving primary power and an output for applying power to the plurality of resonant circuits via a common dc link. The utility interface power converter may include a plurality of solid state switches. A controller is included for controlling the state of the switches using pulse width modulation.

The utility interface power converter aims to provide a stable dc voltage source to the plurality of resonant circuits. It should also draw electrical energy from the utility prime power supply in accordance with various regulations, for example, Engineering Recommendation G5/4. In one embodiment, a 750-1000V dc source is derived from a three phase ac supply, for example. In another embodiment, the utility is of poor quality, for example, derived from an electricity generator which may produce variations in quality as a result of the nature of the loads connected to this source. Use of a high frequency high power converter system in accordance with the invention may provide significant operational capabilities by allowing connection to a poor utility or operating on a generator in remote locations or on mobile systems.

### BRIEF DESCRIPTION OF THE DRAWINGS

Some embodiments of the present invention will now be described by of example only, and with reference to the accompanying drawings, in which:

FIG. 1 schematically illustrates a system in accordance with the invention;

FIG. 2 schematically illustrates part of the system of FIG. 1;

FIG. 3 is a graph showing the voltage-current characteristics of a magnetron;

FIG. 4 schematically illustrates in greater detail the utility interface power converter included in system of FIG. 1;

FIG. 5 schematically illustrates in greater detail the magnetron interface power converter included in the system of FIG. 1;

FIG. 6 schematically illustrates operation of the system of FIG. 1;

FIGS. 7 and 7b schematically illustrate the capacitor arrangement of the magnetron interface power converter of FIG. 5;

FIG. 8 schematically illustrates a control arrangement;

FIG. 9a illustrates an inverter and FIG. 9b schematically illustrates three inverters and their outputs;

FIG. 10 schematically illustrates soft switching; and

FIG. 11 schematically illustrates a control arrangement which includes tracking.

### DETAILED DESCRIPTION

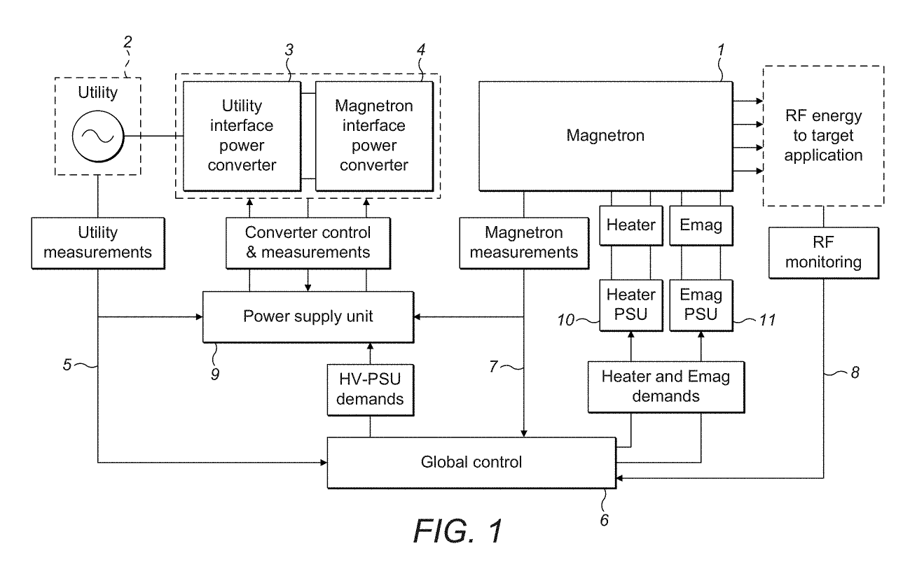

With reference to FIG. 1, a high frequency high power generator system includes a magnetron 1 which generates a high power, continuous wave (CW) RF output for use in industrial processing or for other purposes. In this embodiment, the RF power level can be 100 kW, and the frequency can be 20-30 kHZ. The magnetron 1 is connected to a prime power source 2, which in this case is the grid, via a utility interface power converter 3 and a magnetron interface power converter 4. The output of the prime power source 2 tends to be variable in quality, with fluctuations in frequency and voltage. Such variations in quality are not detrimental for many types of load. However, where the load is a high power magnetron, supply disturbances can lead to degradation in the quality of the magnetron output and may cause the magnetron to cease operating. If the generator system is deployed in an industrial process this can lead to costly and disruptive shutdown of plant.

The utility interface power converter 3 receives a three phase ac supply from the prime power source 2 and converts it into a 750-1000V dc output to be applied to the magnetron interface 4 with improved stability and quality. The utility interface power converter 3 must also comply with the applicable regulations for drawing electrical energy from the grid.

In another embodiment, the high frequency high power generator system is connected to a local electricity generator as the prime power supply. A local generator typically provides significantly lower quality output than the grid, particularly if the generator has additional demanding loads for other purposes, and usually provides a single phase ac supply which the utility interface power converter 3 converts into a stable 750-1000V dc output.

The magnetron interface power converter 4 receives the 750-1000 dc output of the utility interface power converter 3 and produces a high voltage, low ripple dc source to control the power flow into the magnetron 1 at about 20 kV at 6-6.5 A. The magnetron interface power converter 4 comprises low voltage power electronics, a transformer to give voltage scaling, high voltage rectification and filtering.

Utility measurements providing information about the status of the power source 2 are sent along line 5 to a global control unit 6. The global control unit 6 also receives magnetron measurements on line 7 and RF monitoring data on line 8 from the target application which receives the magnetron output. The measurements and data may be direct readings or could be provided via an intervening measurement module or modules.

A power supply unit (PSU) controller 9 applies control signals to the utility interface power converter 3 and to the magnetron interface power converter 4. The PSU controller 9 also receives measurements from the utility interface power converter 3 and the magnetron interface power converter 4 to provide feedback to assist in adjusting the control signals. The PSU controller 9 also receives utility measurements and magnetron measurements on lines 5 and 7 respectively. In addition, the global control unit 6 also sends control signals to the PSU controller 9. The global control unit 6 also sends demand signals to the magnetron heater PSU 10 and the magnetron electromagnet PSU 11.

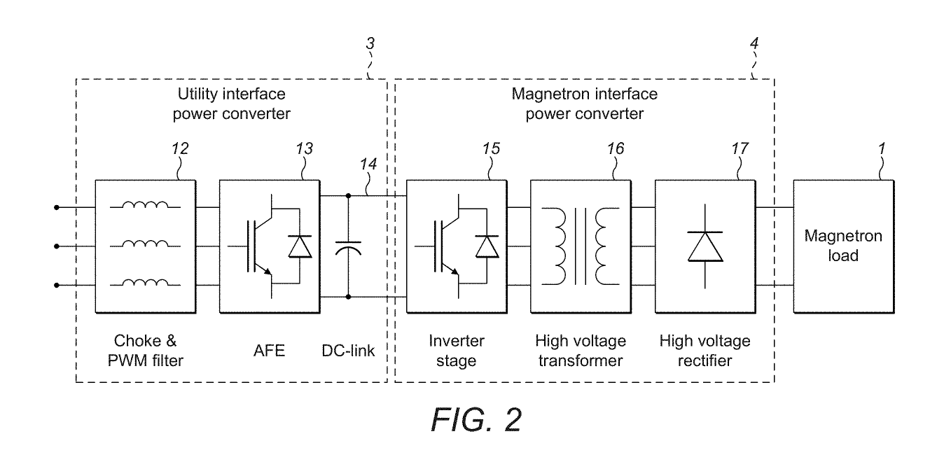

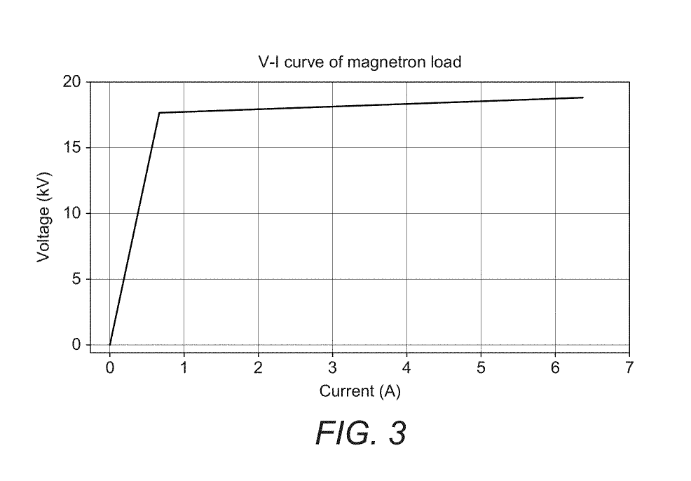

With reference to FIG. 2, the utility interface power converter 3 includes a choke and pulse width modulator filter 12 which is connected to the prime power source. The output of the choke and pulse width modulator filter 12 is applied to an active front end module 13 which has a dc-link output 14 connected to an inverter stage 15 included in the magnetron interface power converter 4. The output of the inverter stage 15 is applied via a resonant tank, a high voltage transformer 16 and high voltage rectifier 17 to the magnetron 1. FIG. 3 shows the voltage-current characteristics of a magnetron load. Due to the highly non-linear resistance characteristics of a magnetron, when the voltage applied to the magnetron 1 is below the magnetron threshold value, the magnetron load behaves like a large resistor. Once the magnetron begins conducting, the effective resistance drops and the magnetron current increases. The threshold value is set by the electromagnet current, allowing the magnetron to operate through different voltage-current curves. The location of the threshold point determines the slope of the resistance curve after the magnetron starts to conduct. A small slope value implies that any small voltage ripple will cause a large variation in the current supplied to the magnetron and downgrade the quality of the RF produced.

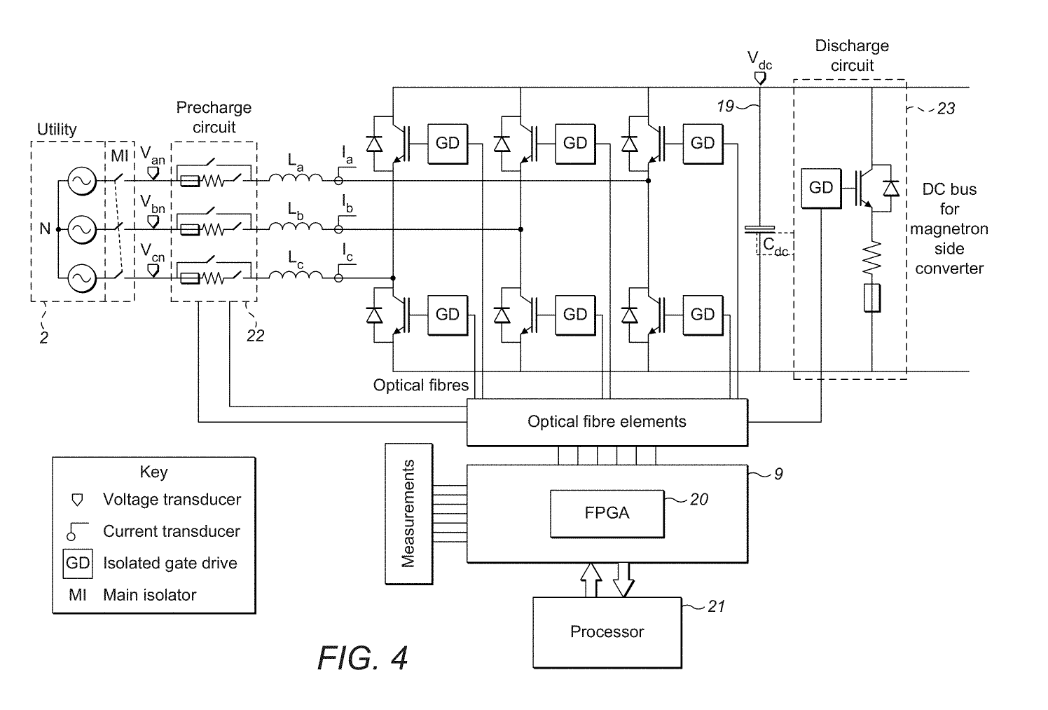

With reference to FIG. 4, which shows part of the system of FIG. 1 in greater detail, the utility interface power converter 3 includes six IGBTs switch modules, which each include an IGBT switch 18 and an antiparallel diode, arranged in three parallel-connected half-leg configurations and interfaced to a DC bus 19. Measurements of utility voltages and currents and the DC link voltage are taken and the isolated and scaled measurement signals applied to the PSU controller 9 which includes an FPGA card 20 having ten Analogue to Digital (A2D) channels. A processor 21 samples the transducer outputs at the FPGA card 20 at a pre-determined interrupt frequency. The performance of the control mechanism is evaluated during an interrupt period between samples using the current sample of data. The global control unit 6 sends pulse width modulation (PWM) demands to the FPGA card 20 where the PWM signals are converted into pulses. The resulting PWM pulses are transmitted to gate drive circuits of the IGBT switches 18 via fibre optic lines. The isolated gate drive circuits level shift these pulses to drive the IGBT switches 18 into ON and OFF states. This enables the utility interface power converter 3 to produce a pulse width modulated voltage which controls the required power flow through the utility interface power converter 3 whilst complying with unity Displacement Power Factor (DPF) at the prime power source 2.

A pre-charge circuit 22 is included between the prime power source 2 and the IGBT switch modules to prevent the IGBT switches 18 from becoming damaged or destroyed when the prime power source 2 is connected. All sinusoidal rectifiers require an arrangement to pre-charge the DC link of the converter to the peak line to line magnitude of the supply voltage. Without such an arrangement, as soon as the converter is connected the prime power source 2, a large inrush current will flow, potentially stressing or destroying diodes of the IGBT switch modules which form an uncontrolled three phase diode bridge for this period of operation.

The pre-charge circuit 22 uses two parallel paths on each phase, one which has a path via a resistor which limits in rush current and the other which is effectively a short circuit. For pre-charging of the DC link capacitor, the resistive path is operated first on all phases and the DC link capacitor is charged through the current limiting resistor to the peak line to line voltage of the supply. At this point, the main contactor is activated and the resistive path is opened, completing the pre-charge cycle and allowing normal circuit operation to commence. Interlocking ensures that the resistive path is not in circuit when the converter is operational and drawing significant power from the supply as losses would be very high in the pre-charge resistors. In other embodiments, a thyristor based pre-charge auxiliary circuit is used instead of the contactors and resistors arrangement shown in FIG. 4.

The utility interface power converter 3 also includes a discharge circuit 23, or similar system, which allows for safe discharge of stored charge in the system under adverse operating conditions or when shutting down the system.

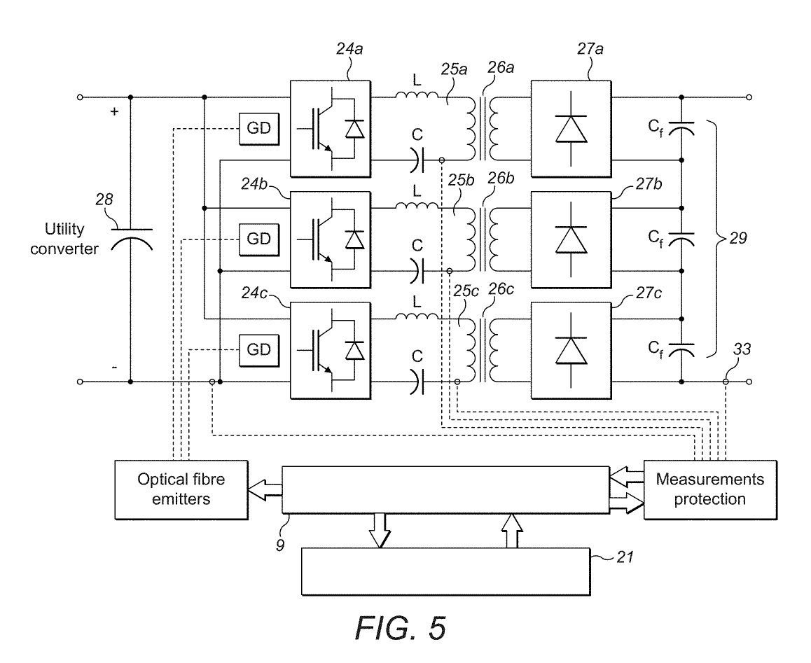

With reference to FIG. 5, the magnetron interface power converter 4 has a three-paralleled single phase configuration, giving high efficiency characteristics for a wide range of operating points and good resilience in the presence of imbalances in the resonant circuits. Each phase or branch of the magnetron interface converter 4 includes a single phase H-bridge inverter 24a, 24b and 24c with its associated respective resonant circuit 25a, 25b and 25c, high voltage transformer unit (HVTRU) 26a, 26b and 26c and rectification stages 27a, 27b and 27c. Each inverter 24a, 24b and 24c includes four bidirectional semiconductor switches which in this case are IGBT switches with antiparallel diodes. Thus twelve IGBT switches are included in total.

The inverters 24a, 24b and 24c produce a balanced set of quasi-square wave voltages with variable frequency and duty cycle to excite the resonant circuits (or tanks) 25a, 25b and 25c. In one embodiment, the frequency can be 20 kHz, and the duty cycle can be π. During the inverter operation, both the frequency and duty cycle can be varied.

A DC-link capacitor 28 is connected across the three inverters 24a, 24b and 24c and is supplied by output of the utility interface power converter 3. The DC-link capacitor 28 may be considered as a DC voltage source with amplitude of 1 kV.

A capacitive filter arrangement 29 follows the rectification stages 27a, 27b and 27c and builds up the voltage required to drive the magnetron load.

Each phase of the multi-phase configuration contributes one third of the overall power and thus constraints on the semiconductor devices and resonant elements are significantly less onerous compared to an arrangement in which all of the overall power is carried by only one phase. A mutual phase shift of 120 degrees is set between the three square wave voltages at the inverter outputs so as to provide ripple cancellation on the load side.

The output of each inverter 24a, 24b and 24c is applied to its respective resonant circuit 25a, 25b and 25c to tune the phase shift between the inverter voltage and current. This enables soft-switching transitions to be achieved and thus high conversion efficiency at high switching frequencies. In this embodiment, the tank quality factor Q, which defines the ratio between the energy stored in the tank and the energy supplied to the load per switching cycle, is 2.5. The tank resonant frequency is 20 kHz.

The resonant circuits 25a, 25b and 25c are series resonant series loaded (SRSL) resonant tanks. An SRSL resonant tank is able to operate safely under the open circuit condition. Before the magnetron starts to conduct, the effective load seen by the magnetron interface converter 4 is the magnetron dynamic resistance, the value of which is very large and thus it can be treated as an open circuit. In this embodiment, the magnetron dynamic resistance is 26 kg. An SRSL resonant tank provides a lower conduction loss and higher conversion efficiency than would be achieved with a series resonant parallel loaded (SRPL) resonant tank arrangement.

The use of the SRSL resonant tank arrangement enables the magnetron interface converter 4 to operate with a variable operating point across different V-I curves set by the current of the magnetron electromagnet. In this embodiment, for example, the magnetron interface converter 4 operates between 14 kV to 19 kV and 90 kW to 120 kW. The magnetron interface converter design and component selection are derived from a nominated working point that determines the maximum output power. For example, at Vout=19 kV and Pout=120 kW, the corresponding equivalent resistance is 3 kg. After the magnetron has started to conduct, the voltage increases from the threshold value to the nominated value, leading to the load resistance reducing from 26 kΩ to 3 kΩ.

Each HVTRU 26a, 26b and 26c has a single primary winding and a plurality of secondary windings. The use of a single primary winding is advantageous as it minimizes parasitic parameters and facilitates manufacture.

The HVTRUs 26a, 26b and 26c step up the voltage from the resonant circuits 25a, 25b and 25c to the level that is required by the magnetron load. The HVTRUs 26a, 26b and 26c also provide electrical isolation between the resonant circuits 25a, 25b and 25c and the rectification stages 27a, 27b and 27c. The secondary winding voltages of the three HVTRUs 26a, 26b and 26c are rectified by the respective single phase rectification stages 27a, 27b and 27c with the aim of completely decoupling the phase-to-phase interaction.

Each of the SRSL resonant circuits 25a, 25b and 25c appears as a sinusoidal current source for the subsequent HVTRUs 26a, 26b and 26c. Thus only capacitance is required in the filtering stage following the rectification stages 27a, 27b and 27c. There is no need to use an inductively smoothed rectifier as only parasitic inductance is present.

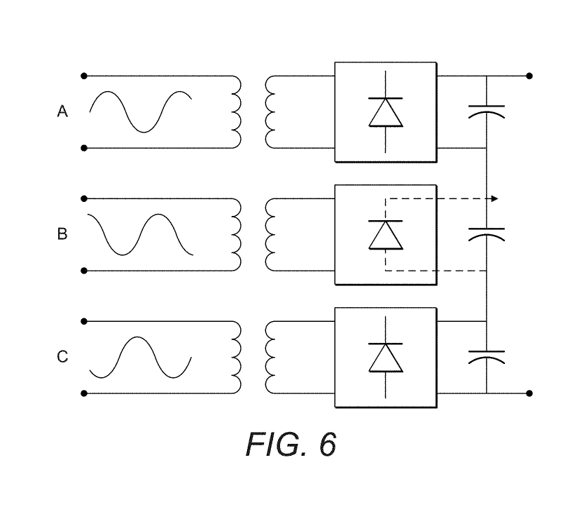

As the three phases are decoupled, the converter is capable of phase fault ride through. For example, if Phase B is broken, the converter can operate with Phase A and C only to produce a lower voltage output. The fault in a phase can be anywhere, providing that the DC-link is healthy and there is a healthy arm in the faulty phase rectifier to bypass current, for example, as shown in FIG. 6 in the case where phase B is faulty and the bypass path is indicated by a broken line.

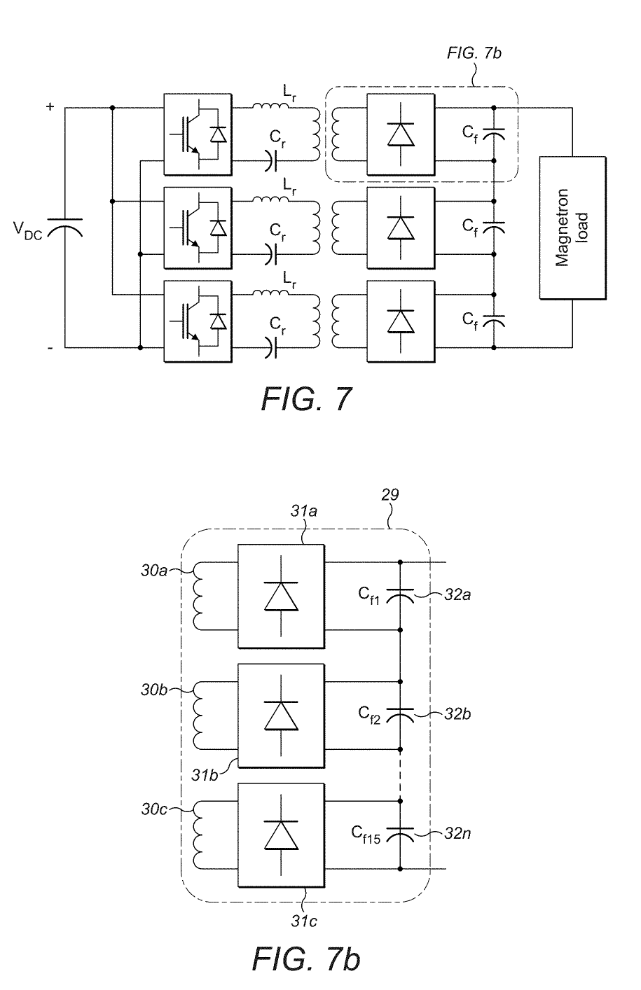

FIG. 7 shows part of the arrangement shown in FIG. 5 with FIG. 7b being an expanded view of part of the capacitive filter arrangement 29 for one branch. Each of the plurality of secondary windings 30a, 30b and 30c of the HVTRU 26a is connected to a respective full bridge diode rectifier 31a, 31b . . . 31n which has a capacitance 32a, 32b . . . 32n across its outputs. The capacitances 32a, 32b . . . 32n are connected in series. The two other branches have the same capacitor configuration and the capacitances for all three branches are connected in series across the magnetron load.

The quality of the RF output produced by the magnetron 1 is directly affected by the ripple and variation in the current which is applied to the magnetron 1. A closed-loop current control arrangement is used to control the output power supplied to the magnetron load. Five current variables are measured for the use in output current control and protection: the output current of the magnetron interface power converter 4 supplied to the magnetron 1, the total current provided by the DC-link 14, and the currents flowing through the three resonant circuits or tanks 25a, 25b and 25c. The measurements are taken using optical or other appropriate transducers and the isolated and scaled measurement signals interfaced with the FPGA 20 and processor 21 previously discussed with respect to FIG. 4. The DC-link voltage is monitored and regulated by the utility interface power converter 3. Using the voltage level of the DC-link 14 and the output current demand, the corresponding gate signals for the IGBT switches of inverters 24a, 24b and 24c are determined by the FPGA 20 and processor 21 which transmit control signals to the gate drive circuits of the IGBT switches of inverters 24a, 24b and 24c via fibre optic lines, shown as broken lines on FIG. 5.

The magnetron 1 can be operated along different V-I curves by controlling the current of the magnetron electromagnet. The electromagnet current and the target RF output power of the magnetron 1 are used together to arrive at a corresponding magnetron current reference value, Ioutput*. In this embodiment, a 2-D look-up table is included in the global control unit 6 and is used to obtain Ioutput* from the electromagnet current and target RF power.

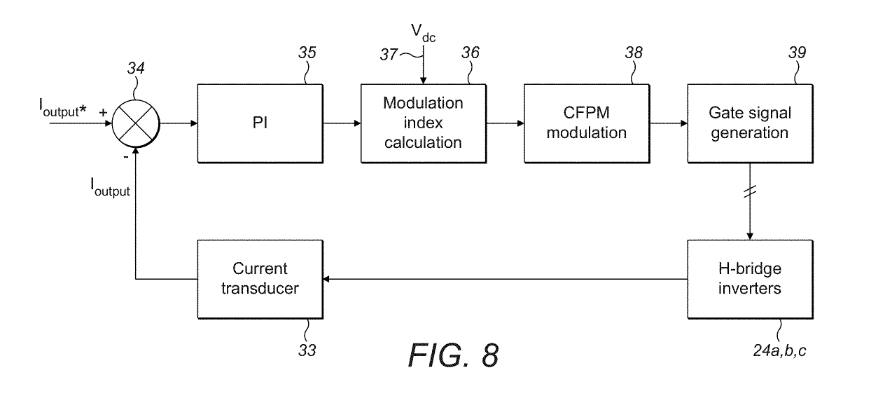

With reference to FIG. 8, a high bandwidth current transducer 33 measures the current Ioutput flowing to the magnetron load 1. The measured current Ioutput is compared with current reference Ioutput* at a comparator 34 to give an error signal which is transmitted to a proportional integral (PI) controller 35. The output of the PI controller 35 is applied to a modulation index calculator 36 which also receives the actual voltage of the DC-link 14 at 37 and uses the inputs to calculate the corresponding converter modulation index (MI) from:

$$MI = \frac{{F}^{2}}{( {F}^{4} {Q}^{2} + {F}^{2} + {Q}^{2} - 2 {F}^{2} {Q}^{2} )}$$

$$ϕ = arc tan ( Q ( F - \frac{1}{F} ) )$$

where Q is the tank quality factor, F is the ratio between the switching frequency and the tank resonant frequency and φ is the phase between the tank input voltage and current.

The resulting modulation index MI is transmitted to a combined frequency and phase shift modulation (CFPM) modulator 38 which controls a gate signal generator 39 to achieve soft-switching of all the IGBT switches of the H-bridge inverters 24a, 24b and 24c.

Use of combined frequency and phase shift modulation enables soft-switching of the IGBT switches to be achieved and thus ensures high conversion efficiency.

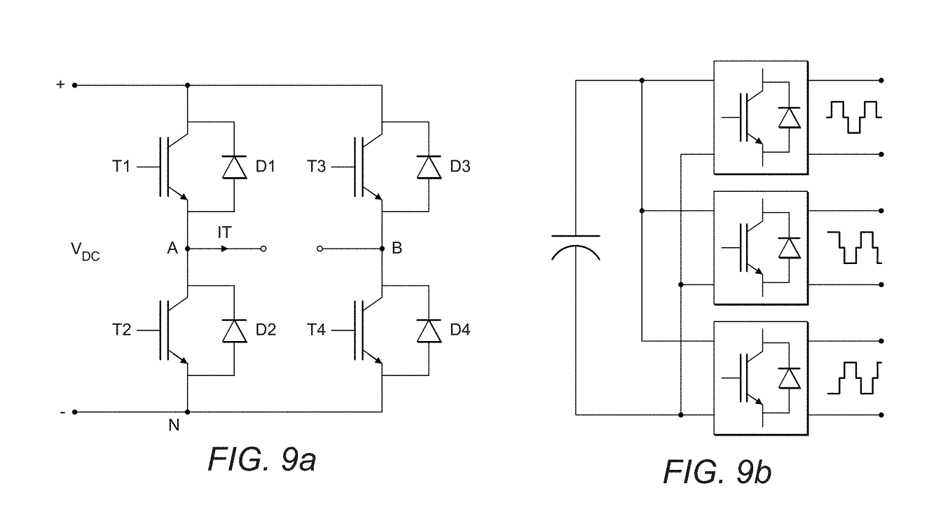

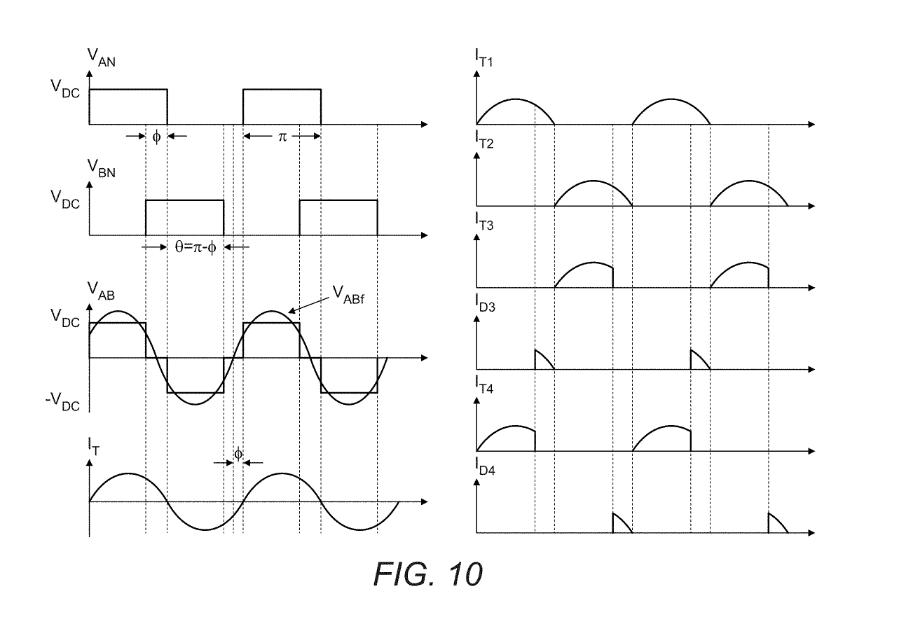

One of the H-bridge inverters 24a, 24b and 24c is shown in FIG. 9a. FIG. 9b illustrates the three phase configuration and the outputs of the inverters 24a, 24b and 24c. FIG. 10 illustrates the concept of CFPM modulation and switching waveform with reference to FIG. 9a where Vdc represents the DC-link voltage; VAN and VBN represent the output voltage from each inverter leg; VAB and VABf represent the tank input voltage and its fundamental component; IT represents the tank current; IT1, IT2, IT3, IT4, ID3 and ID4 represent the current flowing through IGBT T1, T2, T3, T4, Diode D3 and D4, respectively.

When the phase shift of the two H-bridge halves of one of the inverters 24a, 24b and 24c is set to be twice the phase shift between the tank input voltage and current (i.e. Φ=2φ), IGBT T1 and T2 are always switched on and off at the zero crossing point of the tank current, and IGBT T3 and T4 have soft turn-on and hard turn-off. A snubber capacitor slows down the rate of rise of the voltage to achieve an operation that is very close to zero voltage switching (ZVS). Thus, soft-switching is achieved at full power in all IGBT switches of the inverters 24a, 24b and 24c when the system is operating at the nominated working point such that the quality factor Q is substantially constant.

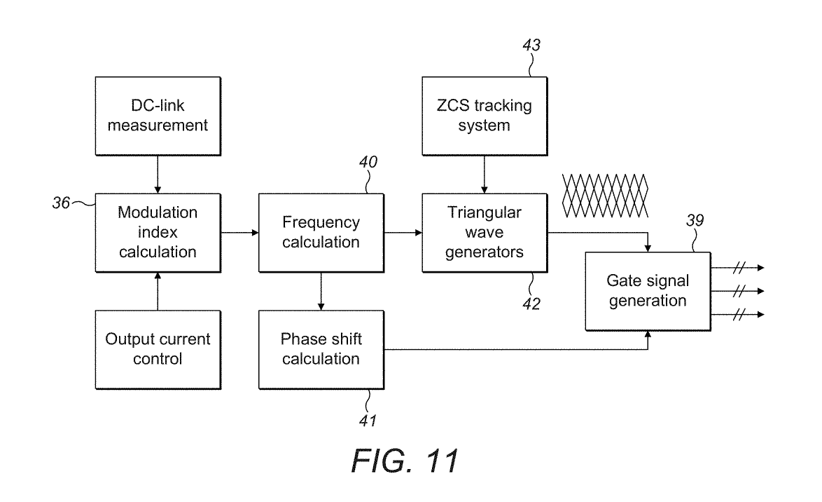

There may be a loss of soft switching when the resonant tank current either leads or lags the tank input voltage. A zero current switching (ZCS) tracking arrangement enables soft switching to be regained. With reference to FIG. 11, the CFPM modulator 38 includes a frequency calculator 40, a phase shift calculator 41 and triangular wave generators 42, the output of triangular wave generators 42 being used to generate the gate signals at 39.

A current transducer detects the resonant tank current information. The value of the resonant tank current can be used with the H-bridge gate signals to determine the actual status between the tank voltage and current can be determined. Using this input, a (ZCS) tracking arrangement 43 generates a compensating frequency component. The compensating frequency component is injected into the triangular wave generators 42 and acts to adjust the switching frequency by increasing or decreasing it. The action of the tracking arrangement is slow compared to the control loop action and thus its influence on the converter operation is low.

In another embodiment the tracking system is not included.

The functions of the various elements shown in the Figures, including any functional blocks labelled as “processors”, may be provided through the use of dedicated hardware as well as hardware capable of executing software in association with appropriate software. Processors and other components may implicitly include, without limitation and where appropriate, digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

1. A high frequency high power converter system comprises: a plurality of resonant tank circuits arranged in parallel, a plurality of transformers, each transformer having a single primary winding and a plurality of secondary windings, and a vacuum electronic device, the output of each resonant tank circuit being applied to a respective different transformer and the outputs of the transformers being arranged to drive the vacuum electronic device.

2. The system as claimed in claim 1, wherein the vacuum electronic device is a magnetron.

3. The system as claimed in claim 2, wherein the magnetron has a continuous wave output.

4. The system as claimed in claim 1, wherein each of the plurality of resonant tank circuits is a series resonant, series loaded resonant tank.

5. The system as claimed in claim 1, including a plurality of inverter circuits, each inverter circuit comprising a plurality of semiconductor switches, and a respective different inverter of said plurality being connected to the input of each of the plurality of resonant tank circuits.

6. The system as claimed in claim 5, wherein each of the plurality of inverter circuits comprises four semiconductor switches connected as an H-bridge.

7. The system of claim 5, wherein the semiconductor switches are IGBT switches.

8. The system as claimed in any of claim 5, wherein the inverter circuits are controlled to provide substantially zero current soft switching of the semiconductor switches.

9. The system of claim 8, and including combined frequency and phase shift modulation, CFPM, to control the inverter circuits to provide substantially zero current soft switching.

10. The system of claim 9, and including a modulation index calculator to calculate the modulation index, MI, used to apply CFPM where
$$MI = \frac{{F}^{2}}{( {F}^{4} {Q}^{2} + {F}^{2} + {Q}^{2} - 2 {F}^{2} {Q}^{2} )}$$
where Q is the tank quality factor and F is the ratio between the switching frequency and the tank resonant frequency.

11. The system as claimed in claim 8, and including a tracking arrangement to counteract any deviation from substantially zero current soft switching of the semiconductor switches.

12. The system as claimed in claim 11, wherein the tracking arrangement generates a correction frequency to provide substantially zero current soft switching of the semiconductor switches.

13. The system as claimed in claim 1, and including a respective high voltage rectifier connected to the each secondary winding of the plurality of secondary windings.

14. The system as claimed in claim 13, wherein a capacitance is connected across the output of each high voltage rectifier and the capacitances are connected in series with one another.

15. The system as claimed in claim 1, wherein three transformers are included and the voltage applied to the primary windings of the three transformers is mutually phase shifted by 120 degrees.

16. The system as claimed in claim 1, and including a utility interface power converter having an input for receiving primary power and an output for applying power to the plurality of resonant circuits via a common dc link.

17. The system as claimed in claim 16, wherein the utility interface power converter includes a plurality of solid state switches and including a controller for controlling the state of the switches using pulse width modulation.

18. The system as claimed in claim 1, wherein the power level is about 100 kW, the switching frequency is some tens of kHz, and the tank quality factor at full power is about 2.5.
